(19) United States
(12) Patent Application Publication
(10) Pub. No.: US 2008/0044331 A1
(43) Pub. Date: Feb. 21, 2008

(54) Method for Reducing the Content of N2O and NOx in Gases

(75) Inventors: Meinhard Schwefer, Meschede (DE); Joachim Motz, Kelkheim (DE); Rolf Siefert, Rheda-Wiedenbruck (DE)

Correspondence Address: Connolly Bove Lodge & Hutz LLP, 1007 North Orange Street, P.O. Box 2207, Wilmington, DE, 19899, US

(73) Assignee: Uhde Gmbh, Dortmund (DE)

(21) Appl. No.: 11/740,608

(22) Filed: Apr. 26, 2007

Related U.S. Application Data
(63) Continuation of application No. 10/469,392, filed on Jan. 14, 2004, now abandoned.

(30) Foreign Application Priority Data
Mar. 13, 2001 (DE) 101 12 444.9

(51) Int. Cl. B01D 53/86; B01D 53/56

(52) U.S. Cl. 423/213.5; 423/239.2

(57) ABSTRACT

A method of reducing the content of NOₓ and N₂O in gases using a gaseous reducing agent which is used in the amount required for reduction of the NOₓ in the presence of one or more iron-laden zeolites which have no pores or channels having a width of greater than or equal to 7 Ångström in the crystal structure and at temperatures of less than 450° C. in the reaction zone is described. In this method, the flow rate of the gas mixture and/or the amount of catalyst is/are selected so that the desired degree of decomposition of N₂O is achieved. The method can be used, in particular, in nitric acid production, in power stations and in gas turbines.

The present invention relates to a method by means of which the content of N₂O and NOₓ in gases, in particular in process gases or in offgases, can be reduced or eliminated entirely.

Many processes, e.g. combustion processes or the industrial production of nitric acid, result in an offgas laden with nitrogen monoxide NO, nitrogen dioxide NO₂ (here referred to collectively as NOₓ) and nitrous oxide N₂O. While NO and NO₂ have for a long time been recognized as compounds having an ecotoxic relevance (acid rain, smog formation) and threshold values for the maximum permissible emissions of these have been laid down worldwide, nitrous oxide has in recent years increasingly moved into the focus of environmental protection, since it makes a not inconsiderable contribution to the degradation of stratospheric ozone and to the greenhouse effect. For reasons of environmental protection, there is therefore an urgent need for technical solutions which reduce or if possible completely eliminate nitrous oxide emissions together with the NOₓ emissions.

Numerous possible methods are already known for the separate removal of N₂O and of NOₓ.

Thus, the NOₓ concentration is reduced primarily by methods involving catalytic reduction of NOₓ which employ a variety of reducing agents; zeolite catalysts have frequently been described. Apart from Cu-exchanged zeolites, iron-containing zeolites are of particular interest for practical applications. Reducing agents used are, for example, ammonia (cf. U.S. Pat. No. 5,451,387) or hydrocarbons (cf. Feng, K. and W. K. Hall in Journal of Catalysis 166, pp. 368-376 (1997)).

In contrast to reduction of the concentration of NOₓ in offgases, which has been established in industry for many years, there are only a few industrial processes for eliminating N₂O and these are usually based on a thermal or catalytic degradation of N₂O. An overview of catalysts which have been shown to be suitable in principle for the degradation and reduction of nitrous oxide is given by Kapteijn et al. (F. Kapteijn, et al., Appl. Cat. B: Environmental 9 (1996) 25-64).

Once again, Fe- and Cu-zeolite catalysts appear to be particularly useful, either for pure decomposition of N₂O into N₂ and O₂ (U.S. Pat. No. 5,171,553) or for the catalytic reduction of N₂O with the aid of, for example, NH₃ to form N₂ and H₂O.

Thus, JP-A-07 060 126 describes a catalyst for the reduction of N₂O with NH₃ in the presence of iron-containing zeolites of the pentasil type (MFI). Since industrially usable degradation rates are achieved only at temperatures of >450° C., particular demands are made of the thermal stability of the catalyst.

In Catal. Lett. 62 (1999) 41-44 Mauvezin et al. give an overview of the suitability of various, iron-exchanged zeolites of the MOR, MFI, BEA, FER, FAU, MAZ and OFF types for the reduction of N₂O with NH₃. According to this, a decrease of >70% in the N₂O concentration can be achieved by NH₃ addition at 450° C. only in the case of Fe-BEA.

Various processes variants for the simultaneous removal of NOₓ and N₂O which is particularly desirable for reasons of simplicity and economics, may likewise be found in the literature. These always describe the joint reduction of NOₓ and N₂O.

Thus, U.S. Pat. No. 4,571,329 claims a process for the reduction of NOₓ and N₂O by means of ammonia in the presence of Fe-substituted zeolite catalysts which firstly catalyze the reaction of NH₃ with NOₓ to form H O and N₂ and secondly likewise catalyze the reaction of NH₃ with N₂O to form H₂O and N₂. Catalysts mentioned as being suitable are iron-substituted zeolites from the group consisting of mordenite, clinoptilolite, faujasite and zeolites Y. The ratio of NH₃ to NO₂ is at least 1.3.

WO-A-00/48715 describes a process in which an offgas comprising NOₓ and N₂O is passed at temperatures of from 200 to 600° C. over an iron zeolite catalyst of the beta type (=BEA), with the offgas further comprising NH₃ in a ratio of from 0.7 to 1.4 based on the total amount of NOₓ and N₂O. NH₃ in this case likewise serves as reducing agent both for NOₓ and for N₂O. Although the process is carried out as a single-stage process at temperatures of less than 450° C., it has the in-principle disadvantage that, like the above-mentioned methods, it requires an approximately equimolar amount of the reducing agent NH₃ based on the amount of N₂O to eliminate the N₂O content.

JP-A-51/03953 describes a process for the removal of oxides of nitrogen, comprising N₂O and NOₓ, in which N₂O and NOₓ are reduced simultaneously by means of hydrocarbons. As catalyst, use is made of γ-Al₂O₃ or zeolite support on which a metal from the group consisting of Cu, Ag, Cr, Fe, Co, Ni, Ru, Rh and Ir. This method, too, requires the addition of reducing agent in an amount corresponding to the total amount of N₂O and NOₓ.

It is an object of the present invention to provide a simple, economical method of simultaneously reducing the concentration of N₂O and NOₓ in the presence of a single type of catalyst, which can be carried out at a very low operating temperature and requires a minimal consumption of reducing agent.

This object is achieved by the method of the invention.

The present invention provides a method of reducing the content of NOₓ and N₂O in gases, in particular in process gases and offgases, which comprises the measures:
a) adding a reducing agent which can reduce NOₓ and is gaseous under the reaction conditions to the NOₓ- and N₂O-containing gas in the amount required for reduction of the Nₓ,
b) introducing the gas mixture into an apparatus having a reaction zone containing one or more iron-laden zeolites whose crystal structure has no pores or channels having a width greater than or equal to 7 Ångström,
c) setting a temperature of up to 450° C. in the reaction zone and selecting a flow rate of the gas mixture and/or the amount of catalyst so that the desired degree of decomposition of N₂O is achieved.

To carry out the method of the invention, the N₂O- and NOₓ-containing gas is firstly mixed with a gaseous reducing agent, preferably with NH₃, and subsequently passed at a temperature of less than 450° C. at the abovementioned space velocity over the catalyst for the simultaneous removal of N₂O (by decomposition) and NOₓ (by reduction).

According to feature a) of the method of the invention, the reducing agent is added in the amount required for reduction of the NOₓ. For the purposes of the present description, this is the amount of reducing agent necessary to reduce the NOₓ in the gas mixture either in its entirely or down to the desired final concentration without appreciable reduction of the N₂O taking place. In the calculation of the amount of reducing agent, the N₂O content of the gas mixture does not play any role, since the reducing agent acts virtually selectively on NOₓ.

The term space velocity refers to the quotient of the volume of gas mixture per hour divided by the volume of catalyst. The space velocity can thus be set via the flow rate of the gas and/or the amount of catalyst.

In general, the temperature of the gas mixture in the reaction zone is from 250 to 450° C., preferably from 300 to 450° C., in particular from 350 to 450° C.

The temperature, flow rate and amount of catalyst in step c) are preferably selected so that at least 50%, more preferably at least 70% and very particularly preferably at least 80%, of the N₂O are decomposed in the reaction zone.

The reduction of the content of NOₓ and N₂O is carried out in the presence of a single type of catalyst, preferably a single catalyst which consists essentially of one or more iron-laden zeolites.

As reducing agents for the purposes of the invention, it is possible to use substances which have a high activity and selectivity for the reduction of NO₂ and whose selectivity and activity under the chosen reaction conditions is greater than for the possible reduction of N₂O. Reducing agents which can be used for the purposes of the invention are, for example, hydrocarbons, hydrogen, carbon monoxide, ammonia or mixtures thereof, e.g. synthesis gas. Particular preference is given to ammonia.

The amount of reducing agent added must not be appreciably greater than that required for the reduction of NOₓ. In the case of ammonia as reducing agent, use is made, depending on the extent to which the NOₓ content is to be reduced, of up to 1.33 (8/6) mol of ammonia per mole of NOₓ. If a smaller decrease in the NOₓ concentration is wanted, the molar amount of ammonia is 1.33*y per mole of NOₓ; here, y is the percentage of the NOₓ which is to be consumed in the reduction. The required molar ratio of reducing agent to NOₓ can depend on the reaction conditions. It has been found that as the pressure increases or the reaction temperature decreases, the amount of reducing agent required for complete removal of the NOₓ decreases. In the case of ammonia, the amount required drops from the above-mentioned 1.33 mol to 1.0 mol per mole of NOₓ.

Catalysts used are iron-laden zeolites or mixtures of iron-laden zeolites whose crystal structure has no pores or channels having crystallographic diameters greater than or equal to 7.0 Ångström.

It has surprisingly been found that decomposition of N₂O can be brought about at temperatures of <450° C. over such catalysts in the presence of NOₓ and an appropriate amount of reducing agent which is not greater than that consumed in the reduction of NOₓ.

Under the present process conditions, NH₃ does not act as a reducing agent for N₂O but instead selectively reduces the NOₓ present in the offgas.

Without being tied to any theoretical considerations, the following mechanism could provide a physicochemical explanation of the invention:

In the first step of the N₂O decomposition, an oxygen atom is donated to an active center (symbolized by *) of the iron zeolite catalyst in accordance with:
N₂O+*→N₂+O* eq. 1

Under the assumption of an unoccupied active center on the catalyst, this decomposition of N₂O occurs rapidly. However, the removal of the active oxygen atom necessary to form molecular O₂ according to
2O*→O₂+2* eq. 2
is comparatively slow. This means that if the reaction according to eq. 2 is accelerated, degradation of N₂O also occurs more rapidly.

This function is performed by NO which reacts with the sorbed O* according to
NO+O* [symbol] NO₂+* eq. 3

At sufficiently high temperatures, a sufficiently fast reformation of NO according to
2NO₂ [symbol] 2NO+O₂+* eq. 4
occurs in the presence of the catalysts used according to the invention.

At lower operating temperatures, as are particularly preferred for the purposes of the invention, the establishment of the NO/NO₂ equilibrium occurs correspondingly slowly.

Reaction of the O* species is limited by a deficiency of NO.

Since eq. 3 is a chemical equilibrium, complete reaction of O* cannot be effected purely by introduction of NO but also requires removal of NO₂. This is achieved by addition of the gaseous reducing agent, e.g. NH₃, which reacts selectively with NO₂ to form N₂ and H₂O according to
6NO₂+8NH₃→7N₂+12H₂O eq. 5
even at low temperatures.

This means that the presence of NOₓ and addition of a gaseous reducing agent, e.g. ammonia, accelerates the degradation of NO₂ without reaction equivalents of NH₃ being consumed for this purpose. The amount of NH₃ required in the presence of the catalysts used according to the invention is determined by the desired removal of NOₓ. However, it should not be appreciably greater than that required for the reduction of NOₓ, since excess NH₃ blocks the decomposition of N₂O and may at elevated temperatures lead to the undesirable reduction of N₂O by NH₃. The latter is the case particularly when iron zeolites having pores or channels larger than 7 Ångström outside the scope of the invention are used. Examples are zeolites of the BEA type.

The method of the invention therefore makes it possible to carry out both the decomposition of N₂O and the reduction of NOₓ at a uniformly low operating temperature in a single catalyst bed with low consumption of gaseous reducing agents such as NH₃, which has hitherto not been possible using the methods described in the prior art.

This is a great advantage particularly when large amounts of N₂O have to be eliminated.

As a result of the use of iron-containing zeolites, preferably those of the FER, MEL and MFI types, in particular Fe-ZSM-5, the degradation of N₂O by the above method in the presence of NOₓ occurs at low temperatures at which decomposition of N₂O would not take place at all without NOₓ and NH₃.

For the purposes of the invention, the catalyst bed can be configured in any way. It can, for example, be in the form of a tube reactor or radial basket reactor. The way in which the gaseous reducing agent is introduced into the gas stream to be treated can also be chosen freely according to the invention, as long as it is done upstream of the reaction zone. The reducing agent can, for example, be fed into the inlet line upstream of the vessel containing the catalyst bed or directly before the bed. The reducing agent can be introduced in the form of a gas or a liquid or aqueous solution which vaporizes in the gas stream to be treated.

Catalysts used according to the invention preferably comprise >50% by weight, in particular >70% by weight, of one or more iron-laden zeolites. Thus, for example, an Fe-ZSM-5 zeolite together with a further iron-containing zeolite, e.g. an iron-containing zeolite of the MFI or FER type, may be present in the catalyst used according to the invention.

In addition, further additives known to those skilled in the art, e.g. binders, can be present in the catalyst used according to the invention.

Catalysts used according to the invention are preferably based on zeolites into which iron has been introduced by solid-state ion exchange. These are usually produced from commercially available ammonium zeolites (e.g. NH₄-ZSM-5) and appropriate iron salts (e.g. FeSO₄.7H₂O) by mixing these intensively by mechanical means in a ball mill at room temperature. (Turek et al.; Appl. Catal. 184, (1999) 249-256; EP-A-0 955 080). The disclosures of these references are hereby expressly incorporated by reference. The catalyst powders obtained are subsequently calcined at temperatures in the range from 400 to 600° C. in air in a muffle furnace. After calcination, the iron-containing zeolites are washed intensively with distilled water, filtered off and dried. The iron-containing zeolites obtained in this way are subsequently admixed with suitable binders and mixed and, for example, extruded to form cylindrical catalyst bodies. Suitable binders are all customarily used binders; the most useful are aluminum silicates such as kaolin.

According to the present invention, the zeolites which can be used are laden with iron. The iron content can be up to 25% based on the mass of zeolite, but is preferably from 0.1 to 10%. The crystal structure of the zeolites has no pores or channels having crystallographic diameters greater than or equal to 7.0 Ångström.

The method of the invention also encompasses the use of zeolites in which part of the lattice aluminum is isomorphously substituted by one or more elements, for example is replaced by one or more elements selected from among B, Be, Ga, Fe, Cr, V, As, Sb and Bi. The use of zeolites in which the lattice silicon is isomorphously substituted by one or more elements, for example is replaced by one or more elements selected from among Ge, Ti, Zr and Hf, is likewise included.

Precise details regarding the makeup or structure of the zeolites used according to the invention are given in Atlas of Zeolite Structure Types, Elsevier, 4^{th} Revised Edition 1996, which is hereby expressly incorporated by reference.

Zeolites of the MFI (pentasil) or FER (ferrierite) type are preferred according to the invention. Particular preference is given to zeolites of the Fe-ZSM-5 type.

In the method of the invention, very particular preference is given to using the above-defined zeolite catalysts which have been treated with steam (“steamed”) catalysts. Such treatment dealuminates the lattice of the zeolites; this treatment is known per se to those skilled in the art. These hydrothermally treated zeolite catalysts surprisingly display a particularly high activity in the method of the invention.

Preference is given to using hydrothermally treated zeolite catalysts which have been laden with iron and in which the ratio of extra-lattice aluminum to lattice aluminum is at least 1:2, preferably from 1:2 to 20:1.

The operating temperature of the catalyst over which N₂O and NOₓ are eliminated is, according to the invention, <450° C., very particularly preferably in the range from 350 to 450° C.

The gas laden with nitrogen oxides is usually passed over the catalyst at a space velocity of from 200 to 200 000 h⁻¹, preferably from 5 000 to 100 000 h⁻¹, in particular from 5 000 to 50 000 h⁻¹ and very particularly preferably from 5 000 to 30 000 h⁻¹, based on the catalyst volume.

The choice of operating temperature is, like the space velocity selected, determined by the desired degree of removal of N₂O.

The desired removal of NOₓ is set by the amount of gaseous reducing agent, e.g. NH₃, added. According to eq. 5, this is preferably about 8/6 of the amount of NOₓ to be removed in the case of ammonia, but at high pressures or low temperatures can also assume smaller values, as described above.

The method of the invention is generally carried out at a pressure in the range from 1 to 50 bar, preferably from 1 to 25 bar.

The introduction of the reducing agent upstream of the catalyst bed is carried out by means of a suitable device, e.g. an appropriate pressure valve or appropriately configured nozzles.

The water content of the reaction gas is preferably in the range <25% by volume, in particular in the range <15% by volume.

In general, a relatively low water concentration is preferred, since higher water contents would make higher operating temperatures necessary. This could, depending on the type of zeolite used and the operating time, exceed the hydrothermal stability limits of the catalyst and is thus to be matched to the individual case chosen.

The presence of CO₂ and of other deactivating constituents of the reaction gas which are known to those skilled in the art should also be minimized if possible, since these would have an adverse effect on the degradation of N₂O.

The method of the invention also succeeds in the presence of O₂, since the catalysts used according to the invention have sufficient selectivities to suppress reaction of the gaseous reducing agent such as NH, with O₂ at temperatures of <450° C.

All these influencing factors and also the chosen catalyst loading, i.e. the space velocity, need to be taken into account when choosing the appropriate operating temperature of the reaction zone.

The conversions which can be achieved for N₂O and NOₓ by means of the present method are >80%, preferably >90%. The method is thus superior to the prior art in terms of its performance, i.e. the achievable degrees of conversion of N₂O and NOₓ, and also in respect of its operating and capital costs.

The method of the invention can be employed, in particular, in nitric acid production, for offgases from power stations or for gas turbines. These processes produce process gases and offgases which comprise oxides of nitrogen and from which the oxides of nitrogen can be removed in an inexpensive way by means of the method indicated here.

The invention is illustrated by the following example:

As catalyst, use is made of an iron-laden zeolite of the ZSM-5 type.

The Fe-ZSM-5 catalyst was prepared by solid-state ion exchange starting out from a commercially available zeolite in ammonium form (ALSI-PENTA, SM27). Details of the preparation can be taken from: M. Rauscher, K. Kesore, R. Mönnig, W. Schwieger, A. Tiβler, T. Turek: “Preparation of highly active Fe-ZSM-5 catalyst through solid state ion exchange for the catalytic decomposition of N₂O”, in Appl. Catal, 184 (1999) 249-256.

The catalyst powders were calcined in air at 823K for 6 hours, washed and dried overnight at 383K. After addition of appropriate binders, they were extruded to form cylindrical catalyst bodies which were broken up to give granules having a particle size of 1-2 mm.

As apparatus for reducing the NOₓ and N₂O content, use was made of a tube reactor which was charged with such an amount of the above catalyst that a space velocity of 10 000 h⁻¹ based on the inflowing gas stream resulted. NH₃ gas was added before the reactor inlet. The operating temperature of the reactor was set by means of heating facilities. Analysis of the gas stream flowing into and out of the apparatus was carried out by means of an FTIR gas analyzer.

At the inlet concentrations and operating temperatures indicated below, the degrees of removal of NO₂ and NOₓ reported in table 1 were achieved.

### EXAMPLE 1

375° C. (1A), 400° C. (1B), 425° (1C)

Inlet Concentrations:

1 000 ppm of N₂O, 2 500 ppm of H₂O and 2.5% by volume of O₂ in N₂

### EXAMPLE 2

375° C. (2A), 400° C. (2B), 425° C. (2C)

Inlet Concentrations:

1 000 ppm of N 0, 1 000 ppm of NOₓ, 2 500 ppm of H₂O, 2.5% by volume of O₂ and 1 200 ppm of NH₃ in N₂

TABLE 1

| | | Decrease in | Decrease in |
|---|---|---|---|
| Example | Temperature | N₂O content | NOₓ content |
| 1A | 375° C. | 4.5% | — |
| 2A | 375° C. | 56.2% | 89.9% |
| 1B | 400° C. | 14.7% | — |
| 2B | 400° C. | 79.8% | 91.5% |
| 1C | 425° C. | 33.7% | — |
| 2C | 425° C. | 93.2% | 91.9% |

As is demonstrated in the examples, the presence of NOₓ and the addition of ammonia lead to a dramatic increase in the decomposition of N₂O without NH 3 being consumed for the reduction of N₂O. The achieved decrease of about 90% in the NOₓ content (starting from 1 000 ppm of NOₓ) corresponds within measurement accuracy to the amount of NH₃ added (1 200 ppm) divided by the stoichiometric reaction ratio of 8/6 in accordance with equation 5. On the other hand, the degree of N₂O decomposition at a given NOₓ and NH₃ concentration is dependent only on the operating temperature and the space velocity set.

1-15. (canceled)

16. A method of reducing the content of NOₓ and N₂O in gases which comprises the steps of:
a) adding ammonia as a reducing agent which can reduce NOₓ and is gaseous under the reaction conditions to the NOₓ- and N₂O-containing gas in an amount of up to 1.33 (8/6) mol per mole of NOₓ,
b) introducing the gas mixture into an apparatus having a reaction zone containing one or more iron-laden zeolites whose crystal structure has no pores or channels having a width greater than or equal to 7 Angström,
c) setting a temperature from 350 to 450° C. in the reaction zone and selecting a flow rate of the gas mixture and/or the amount of catalyst by passing the gas over the catalyst at a space velocity of from 5 000 to 50 000 h⁻¹, based on the catalyst volume, so that the desired degree of decomposition of N₂O is achieved and the temperature and flow rate of the gas mixture are set and/or the amount of catalyst is chosen so that at least 50% of the N₂O are decomposed in the reaction zone.

17. The method as claimed in claim 16, wherein in said step c), the temperature and flow rate of the gas mixture are set and/or the amount of catalyst is chosen so that at least 70% of the N₂O are decomposed in the reaction zone.

18. The method as claimed in claim 16, wherein in said step c), the temperature and flow rate of the gas mixture are set and/or the amount of catalyst is chosen so that at least 80% of the N₂O are decomposed in the reaction zone.

19. The method as claimed in claim 16, wherein the NOₓ- and N₂O-containing gas is passed over the catalyst at a space velocity of from 5 000 to 30 000 h⁻¹, based on the catalyst volume.

20. The method as claimed in claim 16, wherein the gas is passed over a single catalyst.

21. The method as claimed in claim 16, wherein the gases are process gases or offgases.

22. The method as claimed in claim 16, wherein iron-laden zeolites are MFI, FER or MEL types as used as catalysts.

23. The method as claimed in claim 22, wherein the catalyst used is an iron-laden zeolite of the MFI type.

24. The method as claimed in claim 23, wherein the iron-laden zeolites of the MFI type is a catalyst of the Fe-ZSM-5 type.

25. The method as claimed in claimed 16, wherein the catalyst is zeolites which have been treated with steam.

26. The method as claimed in claim 16, wherein the catalyst is iron-laden zeolites which have a ratio of extra lattice aluminum to lattice aluminum is at least 0.5.

27. The method as claimed in claim 16, wherein the method is integrated into the process for the production of nitric acid.

28. The method as claimed in claim 16, wherein the method is integrated into the process of operating a gas turbine.

29. The method as claimed in claim 16, wherein the method is integrated into the process of operating a power station.
